(19) United States
(12) Patent Application Publication
(10) Pub. No.: US 2024/0332969 A1
(43) Pub. Date: Oct. 3, 2024

(54) Systems and Methods for Connecting Electrical Appliances to an Electrical Grid

(71) Applicant: Rheem Australia Pty Limited, Rydalmere, New South Wales (AU)

(72) Inventors: Dean Holland CLIFT, Rydalmere, New South Wales (AU); Gary ROSENGARTEN, Rydalmere, New South Wales (AU); Cameron STANLEY, Rydalmere, New South Wales (AU); Lee KERNICH, Rydalmere, New South Wales (AU)

(21) Appl. No.: 18/579,946

(22) PCT Filed: Jul. 28, 2022
(86) PCT No.: PCT/AU2022/050793

§ 371 Date: Jan. 17, 2024

(30) Foreign Application Priority Data
Aug. 2, 2021 (AU) 2021902373
Jul. 21, 2022 (AU) 2022902043

(51) Int. Cl. H02J 3/00; G05B 15/02; G06Q 30/0283; G06Q 50/06

(52) U.S. Cl. CPC H02J 3/0075; G05B 15/02; G06Q 30/0283; G06Q 50/06; H02J 2310/64

(57) ABSTRACT

Disclosed is a system for connecting an electrical appliance to an electrical grid. The system comprises a switch module and a processing system. The switch module is configured to electrically connect the electrical appliance and the electrical grid. The processing system is configured to compare a current electricity price for the electrical grid to a statistical quantity representing electricity prices for the electrical grid over a period, and, based on the comparison, operate the switch module to control the transfer of electricity between the electrical grid and the electrical appliance. The electricity price at a given time comprises the price set by an operator of the electrical grid to purchase from one or more electrical generators enough electricity to meet an expected demand for electricity from the electrical grid at the given time. Also disclosed is a method for connecting an electrical appliance to an electrical grid. Also disclosed are systems and methods for controlling the transfer of electricity between an energy system and one or more external energy sources.

### TECHNICAL FIELD

The present invention relates to systems and methods for connecting electrical appliances to an electrical grid.

### BACKGROUND

Electrical grids should be balanced so that the amount of electricity supplied by a grid at any given time matches the demand for electricity from the grid at that time. Grid balancing is becoming increasingly challenging as electrical generation continues to decentralise and as highly variable, renewable energy sources, such as wind and solar energy, become more widespread.

On the side of the consumer, certain electrical appliances may be configured to operate in ways that vary their load on the electrical grid, which may assist the process of grid balancing. For example, electric water heaters may heat water at fixed times only (usually during off-peak hours), or they may be provided with thermostatic control.

However, these existing solutions do not adjust an electrical appliance's demand for electricity in a dynamic way based on to the amount of energy available from the electrical grid at any given time, so their ability to assist to balance the grid is limited.

It is desired to address or ameliorate one or more disadvantages or limitations associated with the prior art, or to at least provide a useful alternative.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

### SUMMARY

According to one example aspect, there is provided a system for connecting an electrical appliance to an electrical grid. The system comprises: a switch module configured to electrically connect the electrical appliance and the electrical grid; and a processing system. The processing system is configured to: compare a current electricity price for the electrical grid to a statistical quantity representing electricity prices for the electrical grid over a period; and, based on the comparison, operate the switch module to control the transfer of electricity between the electrical grid and the electrical appliance. The electricity price at a given time comprises the price set by an operator of the electrical grid to purchase from one or more electrical generators enough electricity to meet an expected demand for electricity from the electrical grid at the given time.

In certain embodiments, the processing system is configured to operate the switch module to either allow or impede the transfer of electricity between the electrical grid and the electrical appliance. In certain embodiments, the processing system is configured to operate the switch module to increase or decrease the transfer of electricity between the electrical grid and the electrical appliance.

In certain embodiments, the processing system is configured to compare the current electricity price to a quantity representing non-current electricity prices.

In certain embodiments, if the current electricity price is less than the statistical quantity, the processing system is configured to operate the switch module to allow or increase a supply of electricity by the electrical grid to the electrical appliance for powering the electrical appliance. In certain embodiments, if the current electricity price is greater than the statistical quantity, the processing system is configured to operate the switch module to impede or reduce a supply of electricity by the electrical grid to the electrical appliance.

In certain embodiments, the statistical quantity comprises a rolling average of electricity prices for the electrical grid over the period. In certain embodiments, the period excludes times in which the current electricity price applies. In certain embodiments, the period includes times in which the current electricity price applies. In certain embodiments, the period immediately precedes or immediately follows the time in which the current electricity price applies. In certain embodiments, the period does not immediately precede or immediately follow the time in which the current electricity price applies. In certain embodiments, the period is a 24-hour period.

In certain embodiments, to compare the current electricity price to the statistical quantity, the processing system is configured to compare a difference between the current electricity price and the statistical quantity to an index threshold.

In certain embodiments, to compare the current electricity price to the statistical quantity, the processing system is configured to: determine a price index based on the current electricity price and the statistical quantity; and compare the price index to an index threshold.

In certain embodiments, the price index is:

$$α = \frac{\overline{X} - X}{\overline{X}}$$

where α is the index, X is the current electricity price, and X̅ is a rolling average of the electricity prices over the period.

In certain embodiments, the price index is:

$$α = \frac{X}{\overline{X}}$$

where α is the index, X is the current electricity price, and X̅ is a rolling average of the electricity prices over the period.

In certain embodiments, the index threshold is a static threshold. In certain embodiments, the index threshold is a dynamic threshold, and the processing system is configured to set the index threshold based on an urgency for the electrical appliance to receive and/or consume electricity from the electrical grid.

In certain embodiments, the statistical quantity is determined from past electricity prices. In certain embodiments, the statistical quantity is determined from future electricity prices. In certain embodiments, the statistical quantity is further determined from the current electricity price.

In certain embodiments, the electrical appliance is electrically connected to an auxiliary electrical source configured to supply electricity to the electrical appliance and to the electrical grid, and the processing system is further configured to alter an amount of electricity supplied by the auxiliary electrical source to the electrical grid by operating the electrical appliance to control its electrical energy consumption. In certain embodiments, if the current electricity price is lower than the statistical quantity, the processing system is configured to operate the electrical appliance to increase or allow electrical energy consumption by the electrical appliance. In certain embodiments, if the current electricity price is greater than the statistical quantity, the processing system is configured to operate the electrical appliance to reduce or stop electrical energy consumption by the electrical appliance. In certain embodiments, the processing system is further configured to: receive auxiliary supply data indicative of an amount of electricity supplied by the auxiliary electrical source to the electrical appliance; and operate the switch module to control an amount of electricity supplied by the electrical grid to the electrical appliance based on the auxiliary supply data.

In certain embodiments, the electrical appliance comprises a water heater. In certain embodiments, the processing system is configured to operate the switch module based on: the comparison of the current electricity price to the statistical quantity; and an urgency for the water heater to heat water. In certain embodiments, the urgency depends on the temperature of water stored in the water heater, and the processing system is further configured to: receive temperature data indicative of the temperature of water stored in the water heater; and based on the temperature data, operate the switch module to control the transfer of electricity between the electrical grid and the water heater. In certain embodiments, the electrical appliance comprises an energy storage device.

According to another example aspect, there is provided a method for connecting an electrical appliance to an electrical grid. The method comprises: providing a switch module configured to electrically connect the electrical appliance and the electrical grid; comparing a current electricity price for the electrical grid to a statistical quantity representing electricity prices for the electrical grid over a period; and, based on the comparison, operating the switch module to control the transfer of electricity between the electrical grid and the electrical appliance. The electricity price at a given time comprises the price set by an operator of the electrical grid to purchase from one or more electrical generators enough electricity to meet an expected demand for electricity from the electrical grid at the given time.

According to another example aspect, there is provided a switch module for electrically connecting an electrical appliance to an electrical grid. The switch module comprises a processing system configured to: compare a current electricity price for the electrical grid to a statistical quantity representing electricity prices for the electrical grid over a period; and, based on the comparison, operate the switch module to control the transfer of electricity between the electrical grid and the electrical appliance. The electricity price at a given time comprises the price set by an operator of the electrical grid to purchase from one or more electrical generators enough electricity to meet an expected demand for electricity from the electrical grid at the given time. In certain embodiments, the switch module is integrally or separately formed with the electrical appliance.

According to another example aspect, there is provided an electrical appliance comprising: a switch module configured to electrically connect the electrical appliance to an electrical grid; and a processing system. The processing system is configured to: compare a current electricity price for the electrical grid to a statistical quantity representing electricity prices for the electrical grid over a period; and, based on the comparison, operate the switch module to control the transfer of electricity between the electrical grid and the electrical appliance. The electricity price at a given time comprises the price set by an operator of the electrical grid to purchase from one or more electrical generators enough electricity to meet an expected demand for electricity from the electrical grid at the given time. In certain embodiments, the electrical appliance is a water heater.

According to another example aspect, there is provided a system for connecting an electrical appliance to an electrical grid. The system comprises: a switch module configured to electrically connect the electrical appliance and the electrical grid; and a processing system. The processing system is configured to: compare a current electricity price for the electrical grid to a statistical quantity representing electricity prices for the electrical grid over a period; and, based on the comparison, operate the switch module to control the transfer of electricity between the electrical grid and the electrical appliance.

In certain embodiments, the electricity price at a given time is the retail price of electricity at the given time. In certain embodiments, the electricity price at a given time comprises the price set by an operator of the electrical grid to purchase from one or more electrical generators enough electricity to meet an expected demand for electricity from the electrical grid at the given time.

According to another example aspect, there is provided a system for controlling the transfer of electricity between an energy system and one or more external energy sources. They system may comprise at least one processing system configured to: determine a state of charge of an energy-storage electrical appliance of an energy system, wherein the energy system further comprises a local electricity source; determine a first price threshold and a second price threshold based on the state of charge; compare a current electricity price for an electrical grid to a statistical quantity representing electricity prices for the electrical grid over a period; control the energy system to export electricity from the local electricity source when the current electricity price is greater than the statistical quantity by an amount greater than the first price threshold; control the energy system to receive electricity from the electrical grid to power the energy-storage electrical appliance when the current electricity price is less than the statistical quantity by an amount greater than the second price threshold; and control the energy system to allow the energy-storage electrical appliance to consume electricity from the local electricity source when the current electricity price is greater than the statistical quantity by an amount less than the first price threshold or when the current electricity price is less than the statistical quantity by an amount less than the second price threshold. The electricity price at a given time comprises the price set by an operator of the electrical grid to purchase from one or more electrical generators enough electricity to meet an expected demand for electricity from the electrical grid at the given time.

In certain embodiments, the energy system is configured to be electrically connected to a network of electricity prosumers configured for peer-to-peer energy trading, and the at least one processing system is configured to control the energy system to allow the energy-storage electrical appliance to consume electricity from the local electricity source and/or from the network of electricity prosumers through peer-to-peer energy trading when the current electricity price is greater than the statistical quantity by an amount less than the first price threshold or when the current electricity price is less than the statistical quantity by an amount less than the second price threshold.

In certain embodiments, when controlling the energy system to export electricity from the local electricity source, the at least one processing system is further configured to set the electricity consumption of the energy-storage electrical appliance to a minimum level. In certain embodiments, when controlling the energy system to receive electricity from the electrical grid to power the energy-storage electrical appliance, the at least one processing system is further configured to set the electricity consumption of the energy-storage electrical appliance to a maximum level. In certain embodiments, when controlling the energy system to allow the energy-storage electrical appliance to consume electricity from the local electricity source, the at least one processing system is further configured to set the electricity consumption of the energy-storage electrical appliance to match an amount of energy available from the local electricity source and/or from the network of electricity prosumers.

In certain embodiments, the first and second price thresholds are a first and second price index thresholds, respectively, and, to compare the current electricity price to the statistical quantity, the at least one processing system is configured to: determine a price index based on the current electricity price and the statistical quantity; and compare the price index to the first and second price index thresholds. In certain embodiments, the first price index threshold is less than the second price index threshold, and the processing system is configured to: control the energy system to export electricity from the local electricity source when the price index is lower than the first price index threshold; control the energy system to receive electricity from the electrical grid to power the energy-storage electrical appliance when price index is greater than the second price index threshold; and control the energy system to allow the energy-storage electrical appliance to consume electricity from the local electricity source and/or from the network of electricity prosumers when the price index is greater than the first price index threshold and less than the second price index threshold.

In certain embodiments, the at least one processing system is configured to control the energy system to allow the energy-storage electrical appliance to consume electricity from one or more of the local electricity source, the electrical grid, and the network of electricity prosumers when the state of charge is below a minimum level.

According to another example aspect, there is provided a method for controlling the transfer of electricity between an energy system and one or more external energy sources. The method may be a computer-implemented method comprising: determining a state of charge of an energy-storage electrical appliance of an energy system, wherein the energy system further comprises a local electricity source; determining a first price threshold and a second price threshold based on the state of charge; comparing a current electricity price for an electrical grid to a statistical quantity representing electricity prices for the electrical grid over a period; controlling the energy system to export electricity from the local electricity source when the current electricity price is greater than the statistical quantity by an amount greater than the first price threshold; controlling the energy system to receive electricity from the electrical grid to power the energy-storage electrical appliance when the current electricity price is less than the statistical quantity by an amount greater than the second price threshold; and controlling the energy system to allow the energy-storage electrical appliance to consume electricity from the local electricity source when the current electricity price is greater than the statistical quantity by an amount less than the first price threshold or when the current electricity price is less than the statistical quantity by an amount less than the second price threshold. The electricity price at a given time comprises the price set by an operator of the electrical grid to purchase from one or more electrical generators enough electricity to meet an expected demand for electricity from the electrical grid at the given time.

### BRIEF DESCRIPTION OF THE DRAWINGS

Some embodiments of the present invention are described below, by way of example only, with reference to the accompanying drawings, in which:

FIG. 1 shows an example system for connecting a water heater to an electrical grid;

FIG. 2 shows example data sources from which the processing system of FIG. 1 may receive or obtain information;

FIG. 3 shows a flow chart of an example method for connecting an electrical appliance to an electrical grid;

FIG. 4 shows an example energy distribution system;

FIG. 5 shows a plot of example first and second price index thresholds, each as a function of the state of charge of an energy-storage electrical appliance;

FIG. 6 shows a plot of an example linear price index threshold and an example non-linear price index threshold, each as a function of the state of charge of an energy-storage electrical appliance; and

FIG. 7 shows a flow chart of an example method for controlling or managing a transfer of electricity between an energy system and an electrical grid.

### DETAILED DESCRIPTION

Embodiments of the invention provide a system for connecting an electrical appliance to an electrical grid, or for controlling the transfer of electricity between the electrical appliance and the electrical grid. The system comprises a switch module configured to electrically connect the electrical appliance and the electrical grid. The system further comprises a processing system configured to compare an electricity price for the electrical grid at a current time (i.e. a current electricity price) to a statistical quantity representing electricity prices for the electrical grid over a period. Based on the comparison, the processing system is configured to operate the switch module to control the transfer of electricity between the electrical grid and the water heater.

Embodiments of the invention further provide a method for connecting an electrical appliance to an electrical grid, or for controlling the transfer of electricity between the electrical appliance and the electrical grid. The method comprises providing a switch module configured to electrically connect the electrical appliance and the electrical grid. The method further comprises comparing a current electricity price for the electrical grid to a statistical quantity representing electricity prices for the electrical grid over a period. The method further comprises operating, based on the comparison, the switch module to control the transfer of electricity between the electrical grid and the water heater.

In some examples, the electricity price at a particular time or period of time is the wholesale or dispatch price of electricity, which is the price set by an operator of the electrical grid to purchase from one or more electrical generators a sufficient quantity of electricity to meet an expected demand for electricity from the electrical grid at that time or period. That is, the electricity price may be the price of electricity at or during the dispatch period, when electricity purchased from the electrical generators is dispatched to the electrical grid. In some examples, the electricity price at a particular time is the wholesale or dispatch price at that time. In some examples, the current electricity price is the spot-price or real-time price of electricity in the electricity market.

In other examples, the electricity price at a particular time is the retail price of electricity charged at that time by an electricity retailer to an end user or consumer. That is, the price of electricity may be the price of supplying electricity to the consumer at any given time. In some examples, the retail price comprises the wholesale or dispatch price and an additional amount or markup (e.g. a markup including profits and overhead costs) determined by the electricity retailer. In other examples, the retail price does not comprise, or excludes, the wholesale or dispatch price.

In some examples, the statistical quantity represents non-current electricity prices, which may include past or historical electricity prices (i.e. electricity prices at one or more past times, preceding a current or present time) and/or future electricity prices (i.e. electricity prices at one or more future times, following a current or present time). In other examples, the statistical quantity represents both non-current electricity prices (i.e. past and/or future prices) and the current electricity price. Therefore, the statistical quantity may be determined from past electricity prices, future electricity prices, and/or the current electricity price. The statistical quantity may be a mean or average, a rolling average, or any other quantity, measure, combination, or representation of two or more electricity prices at two or more different times.

The electrical appliance may be any device or system (e.g. a collection of devices) configured to use or consume electricity. In some examples, the electrical appliance is an energy-storage electrical appliance, which is an appliance configured to use or consume electricity to store energy in any form, such as in the form of heat, chemical energy, electric charge, or any other form of energy. In some examples, the electrical appliance is an electric water heater configured to store water and to heat the stored water using electricity (i.e. an electric storage water heater). The water heater may also use electricity to perform other functions associated with its operation (e.g. measure temperature). In other examples, the electrical appliance is an energy storage device or an electrical storage device, such as an electric-vehicle battery or any other type of battery, configured to store energy and to convert the stored energy to electricity or an electric potential.

The electrical grid may comprise any electricity distribution network, such as a public electricity distribution network, configured to distribute electrical energy that has been sold and bought on a market, such as a national electricity market, from generators to consumers.

The wholesale or dispatch price of electricity is an indication of the balance of electrical supply and demand: it decreases when electricity supply exceeds demand, and it increases when electricity demand exceeds supply. For example, in a liberalised electricity market, the predicted load on an electrical grid is broadcast by the network provider in a period before dispatch, and electrical generators bid for the supply of electricity to meet the predicted load. Each generator may provide the network operator with a quantity of electricity it is willing to generate and with an asking price or offer price at which it is willing to sell the electricity generated. The predicted load is refined over time (e.g. a few days) as the dispatch period approaches, so that the generators' load schedules can also be refined and offer prices amended. At the dispatch period, the network operator selects, based on the quantity of electricity necessary to satisfy the full demand, one or more of the generators that have submitted the lowest offer prices, and sets the current electricity price to the highest price from among the selected generators' offers; electricity is then purchased from each of the selected generators at that price (e.g. if the electricity demand is 10 MWh, and Generator A bids 3 MWh at 10 c/kWh, Generator B bids 7 MWh at 12 c/kWh, and Generator C bids 7 MWh at 13 c/kWh, the electricity operator sets the spot price to 12 c/kWh, and purchases electricity for said amount from Generators A and B for the dispatch period). Since the demand for electricity is linked to the load on the electrical grid, the spot price at the dispatch period is a reliable indicator of the electrical balance conditions for the electrical grid.

Therefore, by controlling an electrical appliance's connection to the electrical grid based on the real-time price of electricity, the load on the electrical grid may be adjusted in accordance with the state of balance of the electrical grid. In some examples, the electrical appliance is connected to the electrical grid if the current electricity price is reduced relative to non-current electricity prices (e.g. if the current price is lower than a quantity representing the non-current prices), which is indicative of a decrease in the demand or an increase in the supply of electricity. In some examples, the electrical appliance is disconnected from the electrical grid if the current electricity price is increased relative to non-current electricity prices (e.g. if the current price is higher than a quantity representing the non-current prices), which is indicative of an increase in the demand or a decrease in the supply of electricity. Therefore, the invention can balance or assist or contribute to the balancing of the electrical grid.

In addition, the invention can assist in reducing the cost of electricity consumed by an electrical appliance, such as a water heater. Simulations using TRNSYS (Transient System Simulation Tool), a time-series simulation tool that tracks energy flow in a system and has been extensively developed for water heating applications, show the possibility of reducing the cost (at the wholesale spot price) of energy consumed. The simulation results show a cost reduction of 128 percent for a small consumer (one-person household) over a one-year period, which accounts for payments to the consumer for consuming energy due to considerable negative spot prices utilised; a reduction of 89 percent for a medium consumer (two- to three-person household); and a reduction of 59 percent for a large consumer (four- or more-person household). The reductions are relative to a current off-peak water heater, heating from 10 pm to 7 am. All simulations utilised data sets from South Australia in the calendar year 2018. Therefore, the invention may provide cost savings to end users of electricity.

It will be appreciated that the term “processing system” may refer to any electronic processing device or system, or computing device or system, or combination thereof (e.g. computers, web servers, smart phones, laptops, microcontrollers, etc.), and may include a cloud computing system. The processing system may also be a distributed system. In general, processing/computing systems may include one or more processors (e.g. CPUs, GPUs), memory componentry, and an input/output interface connected by at least one bus. They may further include input/output devices (e.g. keyboard, displays, etc.). It will also be appreciated that processing/computing systems are typically configured to execute instructions and process data stored in memory (i.e. they are programmable via software to perform operations on data).

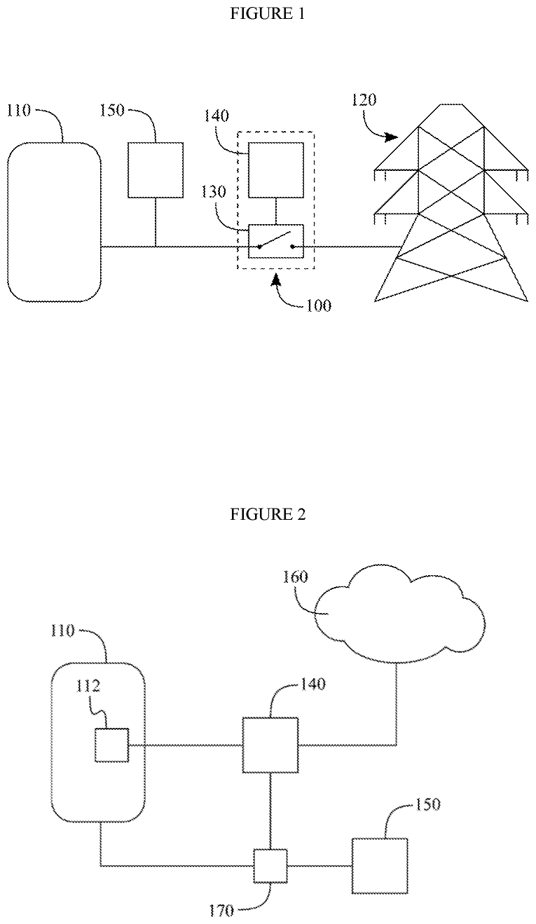

FIG. 1 illustrates an example system 100 for connecting a water heater 110 to an electrical grid 120.

System 100 comprises a switch module 130 and a processing system 140. Switch module 130 and/or processing system 140 may form part of water heater 110 and may be contained in a casing of water heater 110 or they may be separate from water heater 110. Furthermore, switch module 130 and/or processing system 140 may be located either proximally to or remotely from water heater 110.

Switch module 130 is configured to electrically connect or operatively couple to water heater 110 and electrical grid 120. Switch module 130 is further configured to control a transfer or flow of electricity between water heater 110 and electrical grid 120. To this end, switch module 130 may be configured to selectively connect (i.e. connect or disconnect) water heater 110 to electrical grid 120. Switch module 130 may comprise one or more switches, such as electrically operated switches (e.g. MOSFETs or any other transistor), mechanically operated switches, or any other kind of switch. In some examples, switch module 130 is a binary switch module, configured to either allow or impede the transfer of electricity between electrical grid 120 and water heater 110. That is, a binary switch module may simply connect or disconnect water heater 110 to electrical grid 120 without controlling an amount of electricity transferred between them. In other examples, switch module 130 is a modulating switch module, configured to control or modulate an amount of electricity transferred between electrical grid 120 and water heater 110.

Processing system 140 is configured to compare a current electricity price for electrical grid 120 to a statistical quantity representing electricity prices over a period for electrical grid 120. Based on the comparison, processing system 140 is configured to operate or control switch module 130 to control the transfer of electricity between electrical grid 120 and water heater 110.

The statistical quantity may be determined from past electricity prices and/or future electricity prices. In some examples, the current electricity price is also included in the determination or calculation of the statistical quantity. The future electricity prices may be predicted, forecast, or expected electricity prices, as determined by an operator of electrical grid 120 or by any other entity. In some examples, the future electricity prices are predicted based at least in part on the past electricity prices. In some examples, the future electricity prices are predicted based on factors such as a weather forecast, a day of the week, holidays, or any other factor that may influence future electricity prices.

Processing system 140 may be configured to receive or obtain data of the electricity prices, for example, from the energy market operator or the network provider responsible for electrical grid 120. The current electricity price is updated at instants that may be minutes apart, such as every 5 minutes, or every 15 minutes, or any other length of time (e.g. hourly or daily). Processing system 140 may be configured to receive or obtain the current electricity price in real-time or within a time interval shorter than the time interval between price updates (i.e. before the current electricity price expires or becomes outdated).

In some examples, if the current electricity price indicates or represents a reduction in price relative to the non-current electricity prices, processing system 140 may be configured to operate or control switch module 130 to connect water heater 110 to electrical grid 120 and to allow or permit electricity from electrical grid 120 to be supplied to water heater 110 for heating water and/or for performing other tasks associated with the operation of water heater 110.

Alternatively, if the current electricity price indicates or represents an increase in price relative to the non-current electricity prices, processing system 140 may be configured to operate or control switch module 130 to disconnect water heater 110 from electrical grid 120 and to impede or block electricity from electrical grid 120 being supplied to water heater 110 for heating water and/or for performing other tasks associated with the operation of water heater 110. Water heater 110 may then draw electricity from an alternative electrical source (e.g. a battery) to continue its operation or it may cease to consume electricity temporarily.

In some examples, when switch module 130 is a modulating switch module (such as a switch module comprising transistors), processing system 140 is configured to operate switch module 130 to control an amount of electricity transferred, or a rate of transfer of electricity, between electrical grid 120 and water heater 110. In this way, the amount of electricity supplied to water heater 110 from electrical grid 120 may be varied in continuous or discrete steps. In some examples, the amount of electricity supplied to water heater 110 from electrical grid 120 is less than the amount required for water heater 110 to operate at its full heating capacity; in those cases, water heater 110 may draw any additional electricity required for its operation from an alternative electrical source other than electrical grid 120. The portion of electricity that water heater 110 may be allowed to draw from electrical grid 120 may depend on the comparison between the current electricity price and the statistical quantity.

Electricity supplied from electrical grid 120 to water heater 110 may be consumed by water heater 110 as it is received (i.e. in real-time) or it may be stored in an electrical storage device (e.g. a battery) electrically connected to water heater 110 for consumption at a later time. Therefore, in some examples, switch module 130 is electrically connected to an electrical storage device of water heater 110 and/or to an electrical heating element of water heater 110.

Processing system 140 may be configured to receive or determine one or more quantities or values representing electricity prices, such as one or more statistical quantities computed from the non-current and/or current electricity prices, that may then be compared to the current electricity price.

For example, processing system 140 may be configured to determine or calculate a rolling statistical representation of electricity prices, such as a rolling average (also known as a moving or running average). The rolling average may be computed from non-current electricity prices in a period immediately preceding or immediately following a present time in which the current electricity price applies (i.e. past electricity prices consecutively prior or subsequent to the current electricity price). In some examples, the period used to compute the rolling average is a 24-hour period, which allows for consideration of a full diurnal cycle of electricity price changes. In other examples, the period used to compute the rolling average is greater than 24 hours, to reduce the impact of price fluctuations due to, for example, extreme weather events. However, it might not be beneficial to extend the rolling average beyond a certain time period; therefore, in some examples, the period used to compute the rolling average is less than five days. In other examples, the rolling average extends over any other time period, such as a time including or excluding the current time (i.e. the rolling average may include or exclude the current electricity price).

To compare the current electricity price to the statistical quantity representing electricity prices, processing system 140 may be configured to receive or determine a price index based on the current electricity price and the non-current electricity prices (i.e. the price index is a function of the current electricity price and the non-current electricity prices), and to compare the price index to a predetermined amount or threshold. In some examples, the price index is or represents a difference between the current electricity price and statistical quantity representing the electricity prices. In some examples, the price index, a, is:

$$α = \frac{\overline{X} - X}{\overline{X}} \qquad ( 1 )$$

where X is the current electricity price, and X̅ is a rolling average of electricity prices. For example, if X̅ represents a 24-hour rolling average, a price index value of 0.8 indicates that the current electricity price is 20 percent of the average electricity price during the previous or following 24-hour period. For the price index of Equation 1, if the price index is less than or equal to 1, it is increasingly preferable to consume electricity from electricity grid 120 as the price index approaches 1.

In other examples, the price index, α, is:

$$α = \frac{X}{\overline{X}} \qquad ( 2 )$$

where X is the current electricity price, and X̅ is a rolling average of electricity prices. In other examples, the price index is any other function of the current electricity price and of the statistical quantity representing electricity prices.

In some examples, the index threshold to which the price index is compared in order to determine how to operate switch module 130 is a static or fixed threshold (e.g. 0.8, for the index of Equation 1), which does not change automatically.

In other examples, the index threshold is a dynamic threshold, which may be adjusted automatically with no human intervention. In some examples, processing system 140 is configured to set or adjust the index threshold based on a state of charge or storage level of water heater 110, which represents an amount of energy stored by water heater 110, as a relative or absolute measure. In some examples, the state of charge, SOC, is:

$$SOC = \frac{{T}_{mean} - {T}_{cold}}{{T}_{max} - {T}_{cold}} \qquad ( 3 )$$

where Tₘₑₐₙ is the average temperature of the water stored in the water heater, T_{cold} is the temperature of water entering the water heater (e.g. the minimum water temperature), and Tmax is the maximum temperature of water heated by the water heater. In other examples, the index threshold is adjusted based on the temperature of water stored in water heater 110 or, more generally, on an urgency for water heater 110 to heat water.

The index threshold may be increased if the urgency to heat water decreases or if there is no urgency to heat water; alternatively, the index threshold may be decreased if the urgency to heat water increases. An “increase” in the index threshold generally means that a greater reduction in the current electricity price relative to the non-current electricity prices is required before switch module 130 is controlled to allow electricity to be supplied from electrical grid 120 to water heater 110. A “decrease” in the index threshold generally means that a smaller reduction (and, in some examples, even an increase) in the current electricity price relative to the non-current electricity prices is sufficient to operate switch module 130 to allow electricity to be supplied from electrical grid 120 to water heater 110.

For example, the index threshold may be increased if water heater 110 is at full capacity or if the water stored therein is above a certain temperature. In such cases, when there is no or little need for water heater 110 to be connected to electrical grid 120, the index threshold may be increased so that a zero or even a negative current electricity price is required to allow water heater 110 to receive electricity from electrical grid 120. A dynamic threshold may therefore assist in balancing electrical grid 120 more effectively and in further reducing the cost of electricity consumed by water heater 110.

A dynamic index threshold may be advantageous over a static index threshold when system 100 comprises multiple water heaters whose connection to electrical grid 120 is being controlled, as it may reduce the probability of multiple water heaters being reconnected to electrical grid 120 at the same time, potentially damaging the grid's infrastructure due to the sudden increase in load. Instead, by assigning to each water heater a separate dynamic index threshold that changes based on the individual water heater's urgency to heat water, the water heaters would, under normal conditions, be connected to electrical grid 120 at different times.

In addition to being electrically connected to switch module 130, water heater 110 may be electrically connected or operatively coupled to an auxiliary or secondary electrical source or supply 150, which may be a local, on-site, or site-generated electrical source (i.e. an electrical source located proximally to, or at a same site as, water heater 110). Auxiliary electrical source 150 may or may not be electrically connected to electrical grid 120. In some examples, auxiliary electrical source 150 comprises an electrical storage device, such as a battery, configured to store electrical energy for use by water heater 110. In some examples, auxiliary electrical source 150 comprises an electric generator, such as a photovoltaic module, configured to generate electrical energy.

Auxiliary electrical source 150 may be configured to supply electricity to water heater 110. Auxiliary electrical source 150 may further be configured to supply (and/or sell) electricity to electrical grid 120, for example, through an inverter of the auxiliary electrical source. The supply of electricity stored in or generated by auxiliary electrical source 150 to electrical grid 120 may also assist in balancing electrical grid 120. In some examples, when the electricity price indicates that the load on electrical grid 120 has increased, or that the amount of electricity supplied to electrical grid 120 has decreased, processing system 140 is configured to control water heater 110 to reduce or stop (e.g. turn off) its energy consumption, thus allowing more electricity from auxiliary electrical source 150 to be supplied to electrical grid 120 and less to water heater 110. Alternatively, if the current electricity price indicates that the load on electrical grid 120 has decreased, or that the amount of electricity supplied to electrical grid 120 has increased, processing system 140 may be configured to control water heater 110 to increase or allow (e.g. turn on) its energy consumption, thus allowing less electricity from auxiliary electrical source 150 to be supplied to electrical grid 120, and more to water heater 110.

In some examples, in addition to the comparison of the electricity prices, processing system 140 also takes into account an urgency, priority, or need for water heater 110 to heat water when operating or controlling switch module 130. The urgency to heat water may depend on, for example, a state of charge of water heater 110, the temperature of water stored in water heater 110, a time of day, the rate at which water stored in water heater 110 is being used, and/or any other factor. For example, water heater 110 may be configured to maintain the temperature of water stored therein above a minimum level, which may be determined by a need to ensure that a minimum amount of hot water is available and/or by a need to satisfy sanitation requirements, for example, to protect against the growth of Legionella.

In some examples, the urgency to heat water is determined by water heater 110, which may be configured to alert or notify processing system 140 of the urgency so that processing system 140 can operate switch module 130 accordingly. In other examples, the urgency is determined by processing system 140, for example, based on data received or obtained from water heater 110. For example, processing system 140 may be configured to receive temperature data indicative of the temperature of water stored in water heater 110, and, based on the temperature data, operate switch module 130 to either allow or impede transfer of electricity between the electrical grid and the water heater.

The urgency to heat water may be prioritised over the comparison of electricity prices. For example, when an urgency to heat water is determined to exist, processing system 140 may be configured to operate switch module 130 without taking into account the price comparison (i.e. switch module 130 is operated regardless of the current electricity price). In other examples, the urgency to heat water and the price comparison are both considered by processing system 140 to operate switch module 130. In deciding how switch module 130 is to be operated, the price comparison and the urgency may be given the same weight or different weights.

Therefore, processing system 140 may receive or obtain different kinds of data or information to determine how to operate switch module 130. FIG. 2 illustrates some example sources of information from which processing system 140 may receive or obtain data.

One example source of information is one or more temperature sensors 112 of water heater 110. Each temperature sensor 112 is configured to measure the temperature of water stored in water heater 110 at one or more heights of the storage tank of water heater 110. Temperature data from temperature sensors 112 may be used, for example, to determine the state of charge of water heater 110, according to Equation 3.

Another example source of information is an information system 160, which is configured to disclose or provide electricity price data for electrical grid 120, including the current electricity price and/or non-current electricity prices. Information system 160 may comprise a public information system (e.g. a website or page on the World Wide Web) or any other information collection or distribution means. Information system 160 may be an information system of the energy market operator or the network provider responsible for electrical grid 120. For example, in Australia, the price for electricity on the National Electricity Market is published on the website of the Australian Energy Market Operator (AEMO). In some examples, data of past and/or future electricity prices is received or obtained similarly to the current electricity price. In some examples, data of past electricity prices is garnered, collected, or assembled by processing system 140 over time. For example, processing system 140 may store or classify the current electricity price as a past electricity price after an amount of time has lapsed and the price for electricity has been updated.

Another example source of information is an electrical monitor or power sensor 170, which is configured to determine an amount of electricity supplied by auxiliary electrical source 150. Processing system 140 may be configured to receive local supply data from energy monitor 160 indicative of the amount of electricity supplied by auxiliary electrical source 150 to water heater 110. Then, in examples in which switch module 130 is a modulating switch module, processing system 140 may be configured to operate switch module 130 to control an amount of electricity supplied by electrical grid 120 to water heater 110 based on the local supply data. In this way, water heater 110 may be simultaneously supplied with electricity from auxiliary electrical source 150 and electrical grid 120. The combination of the portions of electricity supplied by auxiliary electrical source 150 and electrical grid 120 may correspond to the energy requirements of water heater 110, or it may not exceed a maximum power rating of water heater 110. For example, if local electrical source 150 produces 1 kW, and the maximum electrical consumption of water heater 110 is 3.6 kW, then switch module 130 may be controlled so that electrical grid 120 supplies no more than 2.6 kW.

Processing system 140 may be connected to each source of information through a wired or wireless connection.

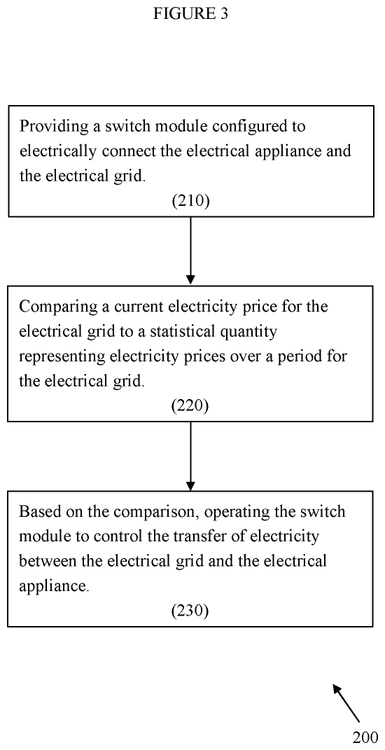

FIG. 3 illustrates a flow chart of an example method 200 for connecting an electrical appliance to an electrical grid.

At step 210, method 200 comprises providing a switch module configured to electrically connect the electrical appliance and the electrical grid.

At step 220, method 200 comprises comparing a current electricity price for the electrical grid to a statistical quantity representing electricity prices over a period for the electrical grid.

At step 230, method 200 comprises operating, based on the comparison, the switch module to control the transfer of electricity between the electrical grid and the electrical appliance.

In some examples, method 200 comprises continuously or periodically iterating through or repeating steps 220 and 230 to account for changes in the price of electricity.

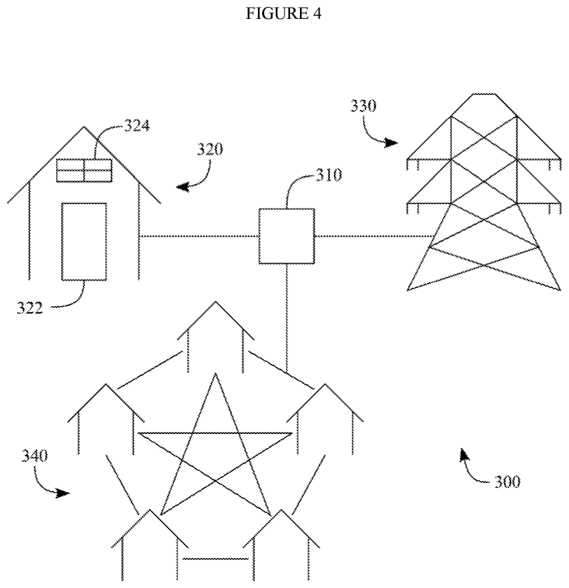

FIG. 4 illustrates an example energy distribution system 300 comprising a processing system 310 configured to control or manage the transfer of electricity between an energy system 320 and external energy sources including an electrical grid 330, and, in some examples, a peer-to-peer (P2P) energy trading network 340. Energy system 320 forms part of, and is electrically connected to, P2P network 340. Energy system 320 is also electrically connected to electrical grid 330.

Energy system 320 comprises an energy-storage electrical appliance 322, such as a water heater, and a local electricity source 324, such as a photovoltaic system, electrically connected to appliance 322. Local electricity source 324 may be configured to generate electrical energy and to supply the electrical energy to appliance 322 and to any other appliance that forms part of energy system 320 (e.g. domestic appliances in a household). Energy system 320 therefore may comprise one or more electricity sources and electrical appliances connected together and, in some examples, located on the same site, such as at a house or office building. Energy system 320 may be considered to define a single producer-consumer (prosumer) unit or node in an electricity network.

P2P energy trading network 340 may comprise one or more prosumers, which may be distributed over an area, at different sites than that of energy system 320. Each prosumer of network 340 may comprise one or more electricity sources connected to one or more electrical appliances (e.g. water heaters). In some examples, each prosumer comprises an energy system like energy system 320.

Processing system 310 is configured to determine a state of charge of appliance 322. The state of charge may be determined from sensor data, such as temperature data, received by processing system 310 using, for example, Equation 3.

Processing system 310 is further configured to determine a first or lower price index threshold (or energy-export threshold) and a second or upper price index threshold (or grid-energy threshold) based on the state of charge of appliance 322.

Processing system 310 is further configured to compare a current electricity price for electrical grid 330 to a statistical quantity representing electricity prices for electrical grid 330 over a period. In some examples, this may include determining a price index based on the current electricity price and the statistical quantity (using, for examples, Equation 1 or 2), and comparing the price index to the first and second price index thresholds. The value of the price index relative to the first and second price index thresholds determines how processing system 310 controls energy system 320.

The different ways in which energy system 320 operates are further explained with reference to the plot in FIG. 5, in which the horizontal axis represents the state of charge of appliance 322, and the vertical axis represents the price index for electrical grid 330 calculated with Equation 1 using a rolling average for the previous 24-hour period as the statistical quantity.

In some examples, processing system 310 is further configured to compare the state of charge of appliance 322 to a minimum level (i.e. a state of charge threshold). If the state of charge of appliance 322 is below the minimum level, corresponding to region 410 in FIG. 5, processing system 310 is configured to control or operate energy system 320 to perform an emergency routine (e.g. an emergency heating routine when appliance 322 is a water heater), in which energy is consumed regardless of the real-time price of electricity.

The emergency routine may involve controlling or operating energy system 320 to allow or direct appliance 322 to consume or receive electricity from one or more of, or from a combination of, local electricity source 324, electrical grid 330, and P2P network 340. In some examples, each of these energy sources may be allocated a priority or preference to supply energy to appliance 322 during the emergency routine. For example, local electricity source 324 may be allocated the highest priority, electrical grid 330 may be allocated the lowest priority, and P2P network 340 may be allocated a priority between these two, so that appliance 322 is controlled to first consume energy from local electricity source 324, with any other energy required to raise the state of charge above the minimum level being drawn from P2P network 340, if available, and lastly from electrical grid 330. Therefore, during the emergency routine, external energy for appliance 322 may be purchased either at the rate set by P2P network 340 or at the real-time energy rate for electrical grid 330.

If the state of charge of appliance 322 is at or above the minimum level, the operation of energy system 320, for a given state of charge, depends on the value of the price index relative to the first price index threshold, indicated by line 420, and relative to the second price index threshold, indicated by line 430.

When the price index is lower than the first price index threshold (or, more generally, when the current electricity price is greater than the statistical quantity by an amount greater than the first price threshold), corresponding to region 440 below line 420, processing system 310 is configured to control or operate energy system 320 to export electricity from local electricity source 324 to electrical grid 330 and/or to P2P network 340 (known as “export response” mode). Energy system 320 may therefore operate as a virtual power plant (VPP), providing electrical energy to external appliances or to other consumers. When energy system 320 is operating in export response mode, the electricity consumption of appliance 322 may be set to minimum, and the amount of electrical energy exported from local energy source 324 may be maximised. When appliance 322 is a water heater, this may involve de-energising all the heating elements of the water heater, ceasing all water heating.

Alternatively, when the price index is greater than the second price index threshold (or, more generally, when (i) the current electricity price is greater than the statistical quantity by an amount less than the first price threshold or (ii) the current electricity price is less than the statistical quantity by an amount less than the second price threshold), corresponding to region 450 above line 430, processing system 310 is configured to control or operate energy system 320 to receive or draw electricity from electrical grid 330 to power appliance 322, so that appliance 322 consumes electrical energy from electrical grid 330 (known as “demand response” mode). When energy system 320 is operating in the demand response mode, the electricity consumption of appliance 322 may be set to maximum. When appliance 322 is a water heater, this may involve energising all the heating elements of the water heater, in some examples, with power corresponding to the higher operating power of the heating elements. In some examples, appliance 322 is configured to consume electricity from electrical grid 330, local electricity source 324, and P2P network 340 when operating in demand response mode.

Alternatively, when the price index is between the first and second price index thresholds (or, more generally, when the difference between the current electricity price and the statistical quantity is between the first and second price thresholds), corresponding to region 460 bound by lines 420 and 430, processing system 310 is configured to control or operate energy system 320 to allow appliance 322 to consume energy from local electricity source 324 (and from P2P network 340, when energy system is connected to P2P network 340). In this mode of operation, processing system 310 may be configured to modulate the load or energy consumption of appliance 322 to match the available excess energy from local energy source 324 and P2P network 340 (up to the maximum rating of appliance 322), with any remaining excess energy being exported to electrical grid 330. When appliance 322 is a water heater, this may involve energising the heating elements of the water heater with an amount of power corresponding to the excess power from local energy source 324 and P2P network 340. The quantity of excess electricity available from local energy source 324 and P2P network 340 may depend on contingencies such as the weather (which will influence solar-generated electricity) and the electrical consumption of other appliances (e.g. washing machines, televisions) of energy system 320 connected to local energy source 324.

Processing system 310 may therefore control energy system 320 to function like a virtual power plant, in which energy generated by local electricity source 324 is made available to appliances that form part of P2P network 340. In particular, when the energy sources that form part of P2P network 340 are renewable energy sources, this configuration allows a fleet of appliances (i.e. the appliances forming part of P2P network 340) to sympathetically respond to the load conditions of electrical grid 330, reducing, and in some examples eliminating, the negative impact of excessive energy (especially excessive renewable energy) being injected into electrical grid 330 during periods of low demand (known as the duck curve phenomenon).

It is to be understood, to control the transfer of electricity between energy system 320 and electrical grid 330 and P2P network 340, processing system 310 may be configured to control or operate one or more components (not shown), such as inverters and switches (including switches like switch module 130 described above), through which energy system 320, electrical grid 330, and P2P network 340 are electrically connected, in a way similar to that described above in relation to FIG. 1.

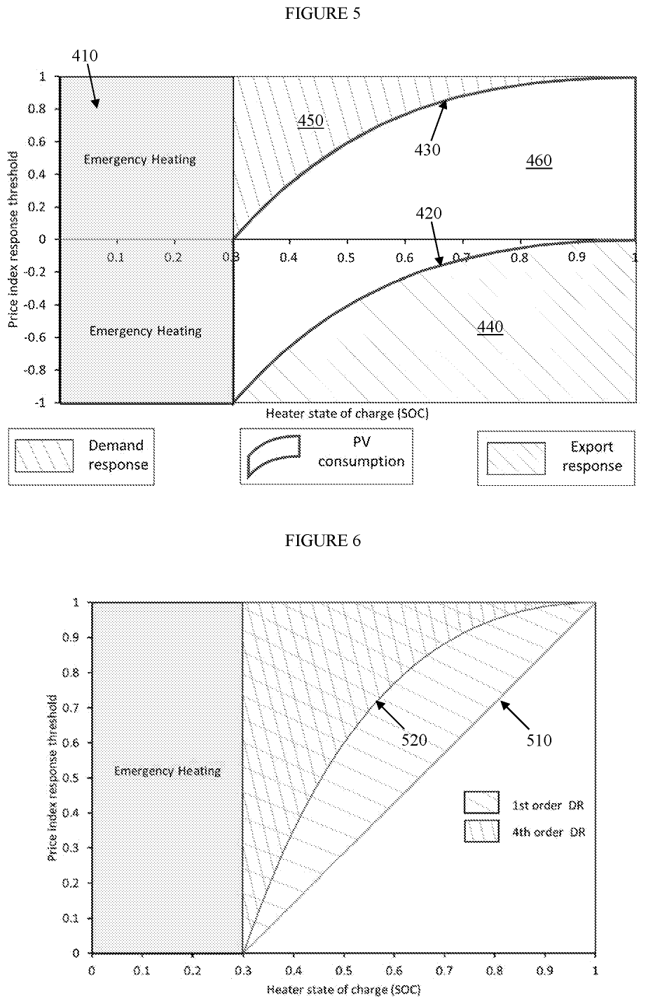

The first and second price index thresholds may be functions of the state of charge of appliance 322. FIG. 6 shows a plot of two example second price index thresholds as functions of the state of charge of appliance 322.

Line 510 represents one example relationship between the second price index threshold and the state of charge, the relationship being a linear relationship defined by the following function:

$${Dpi}_{t} = 1.43 \cdot SOC - 0.43 \qquad ( 4 )$$

where Dpiₜ is the second price index threshold, and SOC is the state of charge of water heater 110 given by Equation 3.

Line 520 represents another example relationship between the second price index threshold and the state of charge, the relationship being a non-linear, fourth-order polynomial relationship defined by the following function:

$${Dpi}_{t} = 1.84 \cdot {SOC}^{4} + 7.35 \cdot {SOC}^{3} - 12.16 \cdot {SOC}^{2} + 9.63 \cdot SOC - 1.98 \qquad ( 5 )$$

The domain of Equations 4 and 5 comprises values of the state of charge (SOC) greater or equal to 0.3 (i.e. the minimum value of the state of charge outside of the emergency heating regime) and less than or equal to 1 (i.e. the maximum possible value of the state of charge according to Equation 1).

An appliance controlled on the basis of the price index threshold of Equation 5, which increases with the state of charge more rapidly compared to that of Equation 4, might have a lower average state of charge than an appliance controlled on the basis of the price index threshold of Equation 4, and might therefore require more frequent emergency heating.

It is to be understood that the values of the parameters in Equations 4 and 5 and the value of the minimum state of charge are for the purpose of example only, and other values may be used. In some examples, the first and second price index thresholds are monotonically increasing functions of the state of charge of appliance 322, so that both the first and second price index thresholds increase as the state of charge increases (as shown in FIG. 5). In other examples, the first and second price index thresholds are any function of the state of charge of water heater, including any linear or non-linear function.

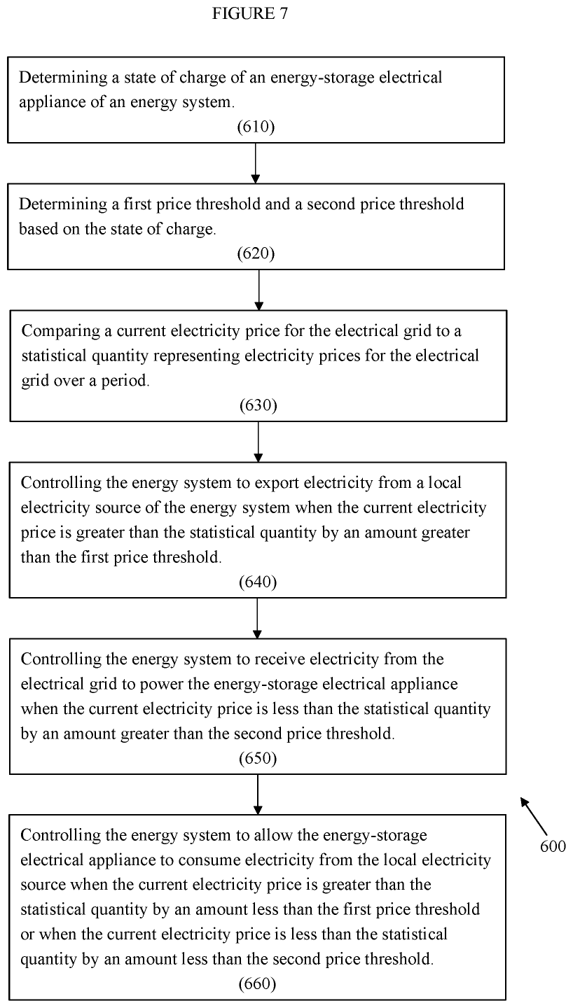

FIG. 7 illustrates a flow chart of an example method 600 for controlling or managing a transfer of electricity between an energy system, an electrical grid, and, in some examples, a P2P energy trading network.

At step 610, method 600 comprises determining a state of charge of an energy-storage electrical appliance of an energy system.

At step 620, method 600 comprises determining a first price threshold and a second price threshold based on the state of charge.

At step 630, method 600 comprises comparing a current electricity price for the electrical grid to a statistical quantity representing electricity prices for the electrical grid over a period.

At step 640, method 600 comprises controlling the energy system to export electricity from a local electricity source of the energy system when the current electricity price is greater than the statistical quantity by an amount greater than the first price threshold.

At step 650, method 600 comprises controlling the energy system to receive electricity from the electrical grid to power the energy-storage electrical appliance when the current electricity price is less than the statistical quantity by an amount greater than the second price threshold.

At step 660, method 600 comprises controlling the energy system to allow the energy-storage electrical appliance to consume electricity from the local electricity source when the current electricity price is greater than the statistical quantity by an amount less than the first price threshold or when the current electricity price is less than the statistical quantity by an amount less than the second price threshold.

In some examples, method 600 comprises continuously or periodically iterating through or repeating steps 610, 620, and 630 to account for changes in the state of charge of energy-storage electrical appliance, with the step of controlling the energy system (i.e. step 640, 650, or 660) being selected accordingly.

Optional embodiments may also be said to broadly include the parts, elements, steps and/or features referred to or indicated herein, individually or in any combination of two or more of the parts, elements, steps and/or features, and where specific integers are mentioned which have known equivalents in the art to which the invention relates, such known equivalents are deemed to be incorporated herein as if individually set forth.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A system for connecting an electrical appliance to an electrical grid, the system comprising:
a switch module configured to electrically connect the electrical appliance and the electrical grid; and
a processing system configured to:
compare a current electricity price for the electrical grid to a statistical quantity representing electricity prices for the electrical grid over a period; and
based on the comparison, operate the switch module to control the transfer of electricity between the electrical grid and the electrical appliance.

2. The system of claim 1, wherein the processing system is configured to operate the switch module to (1) either allow or impede the transfer of electricity between the electrical grid and the electrical appliance and/or (2) increase or decrease the transfer of electricity between the electrical grid and the electrical appliance.

3. (canceled)

4. The system of claim 1, wherein, if the current electricity price is less than the statistical quantity, the processing system is configured to operate the switch module to allow or increase a supply of electricity by the electrical grid to the electrical appliance for powering the electrical appliance, or wherein, if the current electricity price is greater than the statistical quantity, the processing system is configured to operate the switch module to impede or reduce a supply of electricity by the electrical grid to the electrical appliance.

5. (canceled)

6. The system of claim 1, wherein the statistical quantity comprises a rolling average of electricity prices for the electrical grid over the period.

7. The system of claim 6, wherein the period (1) immediately precedes or immediately follows the time in which the current electricity price applies or (2) does not immediately precede or immediately follow the time in which the current electricity price applies.

8-9. (canceled)

10. The system of claim 1, wherein, to compare the current electricity price to the statistical quantity, the processing system is configured to compare a difference between the current electricity price and the statistical quantity to an index threshold.

11. The system of claim 1, wherein, to compare the current electricity price to the statistical quantity, the processing system is configured to:
determine a price index based on the current electricity price and the statistical quantity; and
compare the price index to a price index threshold.

12-13. (canceled)

14. The system of claim 10, wherein the index threshold is (1) a static threshold or (2) a dynamic threshold, and wherein the processing system is configured to set the index threshold based on an urgency for the electrical appliance to consume electricity from the electrical grid.

15. (canceled)

16. The system of claim 1, wherein the statistical quantity is determined from the past electricity prices or (2) future electricity prices.

17. (canceled)

18. The system of claim 16, wherein the statistical quantity is further determined from the current electricity price.

19. The system of claim 1, wherein the electrical appliance is electrically connected to an auxiliary electricity source configured to supply electricity to the electrical appliance and to the electrical grid, and wherein the processing system is further configured to alter an amount of electricity supplied by the auxiliary electricity source to the electrical grid by operating the electrical appliance to control its electrical energy consumption.

20. The system of claim 19, wherein, if the current electricity price is lower than the statistical quantity, the processing system is configured to operate the electrical appliance to increase or allow electrical energy consumption by the electrical appliance.

21. The system of claim 19, wherein, if the current electricity price is greater than the statistical quantity, the processing system is configured to operate the electrical appliance to reduce or stop electrical energy consumption by the electrical appliance.

22. The system of claim 19, wherein the processing system is further configured to:
receive auxiliary supply data indicative of an amount of electricity supplied by the auxiliary electricity source to the electrical appliance; and
operate the switch module to control an amount of electricity supplied by the electrical grid to the electrical appliance based on the auxiliary supply data.

23. The system of claim 1, wherein the electrical appliance comprises a water heater.

24. The system of claim 23, wherein the processing system is configured to operate the switch module based on:
the comparison of the current electricity price to the statistical quantity; and
an urgency for the water heater to heat water.

25. The system of claim 24, wherein the urgency depends on the temperature of water stored in the water heater, and wherein the processing system is further configured to:
receive temperature data indicative of the temperature of water stored in the water heater; and
based on the temperature data, operate the switch module to control the transfer of electricity between the electrical grid and the water heater.

26. The system of claim 1, wherein the electrical appliance comprises an energy storage device.

27. A method for connecting an electrical appliance to an electrical grid, the method comprising:
providing a switch module configured to electrically connect the electrical appliance and the electrical grid;
comparing a current electricity price for the electrical grid to a statistical quantity representing electricity prices for the electrical grid over a period; and
based on the comparison, operating the switch module to control the transfer of electricity between the electrical grid and the electrical appliance;
wherein the electricity price at a given time comprises the price set by an operator of the electrical grid to purchase from one or more electrical generators enough electricity to meet an expected demand for electricity from the electrical grid at the given time.

28. A switch module for electrically connecting an electrical appliance to an electrical grid, the switch module comprising a processing system configured to:
compare a current electricity price for the electrical grid to a statistical quantity representing electricity prices for the electrical grid over a period; and
based on the comparison, operate the switch module to control the transfer of electricity between the electrical grid and the electrical appliance;
wherein the electricity price at a given time comprises the price set by an operator of the electrical grid to purchase from one or more electrical generators enough electricity to meet an expected demand for electricity from the electrical grid at the given time.

29-43. (canceled)
